(19) United States
(12) Patent Application Publication
(10) Pub. No.: US 2019/0102070 A1
(43) Pub. Date: Apr. 4, 2019

(54) Software, systems and related methods for determining aggregate stakeholder views on proposals for change

(71) Applicant: Erez Avraham Ascher, Santa Monica, CA (US)

(72) Inventor: Erez Avraham Ascher, Santa Monica, CA (US)

(21) Appl. No.: 15/721,294

(22) Filed: Sep. 29, 2017

(51) Int. Cl. G06F 3/0484; G06F 21/45

(52) U.S. Cl. CPC G06F 3/04847; G06F 3/0483; G06F 21/45

(57) ABSTRACT

Disclosed is a software application (e.g., a mobile-centric web application) that enables (a) collection of personal views on the favorability, necessity, morality, practicality, and significance of a stated proposal and (b) the creation of a visual representation of the aggregated results as a chart indicating the current consensus view of the stated proposal. Specifically, the software application allows for the entry of proposals for change, structured on the basis of necessity, morality, practicality, and significance which, in addition to favorability, are then selected using a visual indicator such that aggregate views are then displayed graphically.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of software, systems and related methods for determining aggregate stakeholder views on proposals for change.

Specifically, the disclosed software allows people to visually express percentage values indicating favorability, necessity, morality, practicality, and significance regarding a stated proposal, and to view the aggregated results as a chart indicating the current consensus view for the stated proposal.

### Background of the Invention

Changes within a business, organization, or community, like changing the menu at a cafeteria or adding reserved parking spots to a parking structure, will typically affect positively or negatively members of that business, organization, or community (such affected members are referred to herein as “stakeholders”). If a change is implemented without prior feedback from the stakeholders, then a meaningful way does not exist for the proposer to either (a) expect satisfaction from stakeholders after the implementation of a popular change or (b) prevent hostility after implementation of an unpopular change. So, proposers of change frequently want to know the stakeholder's general consensus regarding a proposed change before ultimately deciding whether to move forward or abandon the proposal.

Prior to this disclosure, surveys were the only common ways to obtain a consensus of views regarding a proposed change within a business, organization, or other community. However, surveys are not always satisfactory for obtaining the consensus of stakeholders. Usually, surveys have low response rates and lack transparency for stakeholders. So, a need exists for systems and other methodologies for determining aggregate stakeholder views on proposals for change.

### Related Art

Some related art known to the applicant are set forth below:
US20070288546A1 by Outland Research, LLC (circa 2007) discloses “Groupwise collaborative suggestion moderation system;”
U.S. Pat. No. 9,298,815 by Accenture Global Services (circa 2016) discloses “system for providing an interface for collaborative innovation;”
US20110106721A1 (circa 2011) & U.S. Pat. No. 8,332,232 (circa 2012) by OpinionLab, Inc. disclose “System and Method for Mobile Interaction;”
US20130246301A1 by Uber Technologies, Inc. (circa 2013) discloses “providing user feedback for transport services through use of mobile devices;”
U.S. Pat. No. 9,396,490 by Bazaarvoice, Inc. (circa 2016) discloses “brand response;”
US20140278788A1 by Benbria Corporation (circa 2014) discloses “real-time survey and scoreboard systems;”
US20130041720A1 by Collin R. Spires (circa 2013) discloses a “system and method for real-time satisfaction survey feedback;”
U.S. Pat. No. 8,990,700 by Google, Inc. (circa 2015) discloses a “rating and review interface;”
US20080005761A1 by Symantec Corp (circa 2008) discloses “providing rating information for an event based on user feedback;”
US20130018701A1 by United Sample, Inc. (circa 2013) discloses “capturing and processing data responsive to a task associated with consumer research, survey, or poll;” and,
US20130014137A1 by Symphony Advanced Media (circa 2013) discloses “user impression media analytics platform apparatus and systems.”

### SUMMARY OF THE INVENTION

In view of the foregoing, an object of this specification is to disclose a software application (e.g., a mobile-centric web application) that enables (a) collection of personal views on the favorability, necessity, morality, practicality, and significance of a stated proposal and (b) the creation of a visual representation of the aggregated results as a chart indicating the current consensus view of the stated proposal. Specifically, the software application allows for the entry of proposals for change, structured on the basis of necessity, morality, practicality, and significance which, in addition to favorability, are then selected using a visual indicator such that aggregate views are then displayed graphically.

In one mode of operation, proposers offer proposals for consideration by stakeholders using the disclosed system. Software within the system is configured to enable proposers to define their proposal's title and write a description of their proposal, indicate their view of the necessity, morality, practicality, significance, and any external links or sources of information. Software within the system further is configured to enable proposers to define the stakeholders, e.g., via various methods including by providing email address lists, ZIP codes and the like. Ultimately, the software enables stakeholders to use the system to review proposals that affect them and input their view of the necessity, morality, practicality, significance, and favorability of the proposal. In one embodiment, the stakeholder's views are input via sliders displayed on a graphical user interface (GUI). Both proposers and stakeholders may also view details regarding individual proposals and view the current consensus regarding any given proposal, which is the set of averaged values as indicated by stakeholders using the sliders. When stakeholders express their views, they automatically are shown the current consensus view.

Unlike a survey, the system requires no selection of options or entry of text in order to express one's views. The system may also be distinct from a survey in that it systematizes people's views regarding proposals on the basis of the dimensions of favorability, necessity, morality, practicality, and significance.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which: FIG. 1 is a preferred embodiment of a graphical user interface showing a typical “sign-in” page;

FIG. 2 is a preferred embodiment of a graphical user interface showing a typical “location finder” page;

FIG. 3 is a preferred embodiment of a graphical user interface showing a typical “main menu” page;

FIG. 4 is a preferred embodiment of a graphical user interface showing a typical “”active proposal” page

FIG. 5 is a preferred embodiment of a graphical user interface showing a typical “proposal response” page;

FIG. 6 is a preferred embodiment of a graphical user interface showing a typical “consensus view” page;

FIG. 7 is a preferred embodiment of a graphical user interface showing a typical “view details” page;

FIG. 8 is a preferred embodiment of a graphical user interface showing a typical “expanded description of the view details” page

FIG. 9 is a preferred embodiment of a graphical user interface showing a typical “offer new proposal” page;

FIG. 10 is a preferred embodiment of a graphical user interface showing a typical “detailed offer new proposal” page;

FIG. 11 is a preferred embodiment of a graphical user interface showing a typical “new proposal input” page;

FIG. 11A is a preferred embodiment of a graphical user interface showing a typical “add external link” page;

FIG. 12 is a preferred embodiment of a graphical user interface showing a typical “list of viewers” page;

FIG. 13 is a preferred embodiment of a graphical user interface showing a typical “list detail” page;

FIG. 14 is a preferred embodiment of a graphical user interface showing a typical “create new list” page;

FIG. 15 is a preferred embodiment of a graphical user interface showing a typical “add ZIP codes” page;

FIG. 16 is a preferred embodiment of a graphical user interface showing a typical “add email address” page;

FIG. 17 is a preferred embodiment of a graphical user interface showing a typical “my profile” page;

FIG. 18 is a preferred embodiment of a graphical user interface showing a typical “change password” page;

FIG. 19 is a preferred embodiment of a graphical user interface showing a typical “additional” page;

FIG. 20 is a preferred embodiment of a graphical user interface showing a typical “contact” page;

FIG. 21 is a preferred embodiment of a graphical user interface showing a typical “privacy policy” page;

FIG. 22 is a preferred embodiment of a graphical user interface showing a typical “terms of use” page.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a software application (e.g., a mobile-centric web application) that enables (a) collection of personal views on the favorability, necessity, morality, practicality, and significance of a stated proposal and (b) the creation of a visual representation of the aggregated results as a chart indicating the current consensus view of the stated proposal. Specifically, the software application allows for the entry of proposals for change, structured on the basis of necessity, morality, practicality, and significance which, in addition to favorability, are then selected using a visual indicator such that aggregate views are then displayed graphically. Ultimately, the software enables stakeholders to use the system to review proposals that affect them and input their view of the necessity, morality, practicality, significance, and favorability of the proposal. In one embodiment, the stakeholder's views are input via sliders displayed on a graphical user interface (GUI). Both proposers and stakeholders may also view details regarding individual proposals and view the current consensus regarding any given proposal, which is the set of averaged values as indicated by stakeholders using the sliders. When stakeholders express their views, they automatically are shown the current consensus view.

Suitably, a software application may be installed on computer memory coupled to computer hardware and an output display. In a preferred embodiment, software is configured to display graphical user interfaces on the display and write data to the computer memory. Suitably, the graphical user interfaces may feature various input objects, like command buttons and text entry boxes, for a user's (a) inputting data to a database or (b) navigation between the screens. In a preferred embodiment, a proposer or stakeholder can register a profile with their own personal information (e.g., contact information). Such information may be suitably stored in the database and associated with the proposer or stakeholder profile. The disclosed system is set forth in further detail below with reference to various graphical user interfaces that are presented in the figures.

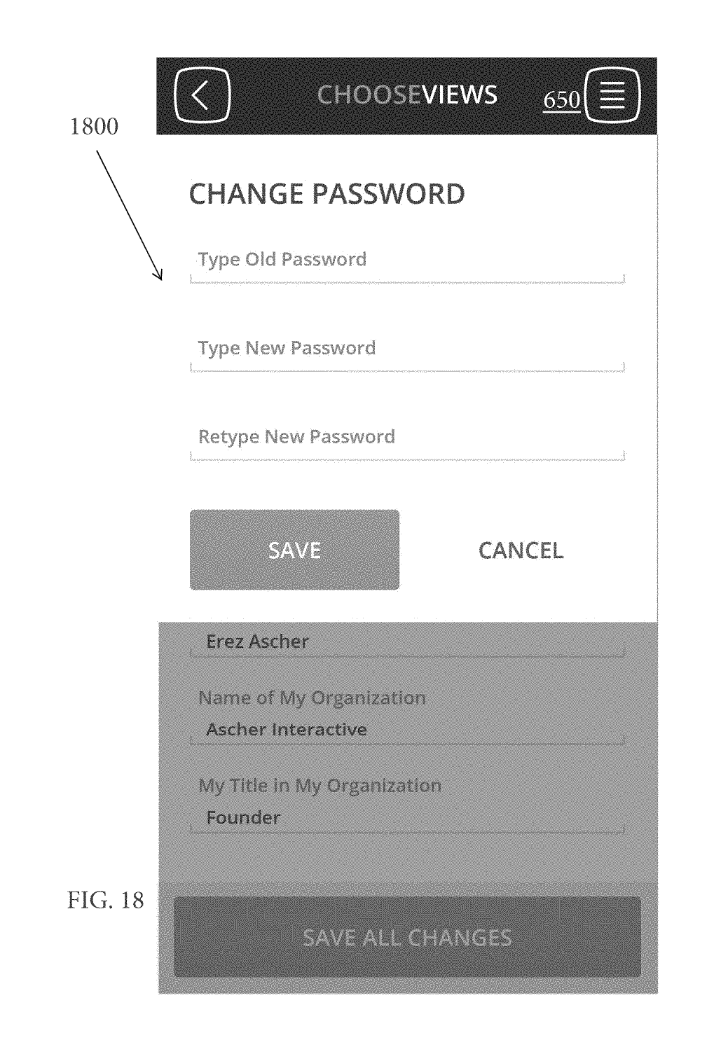

FIG. 1 is a preferred embodiment of a graphical user interface showing a typical “sign-in” page 100. In one embodiment, the purpose of the “sign in” page is to tie the software to a particular user account or profile. As shown, the “sign in page” 100 comprises: a command button 110 for setting a profile that is associated with a social media profile (e.g., a Facebook® profile); another command button 120 for setting a profile that is associated with a secondary social media profile (e.g., a Google® account profile); a text entry bar 130 for data entry of an unique user profile name (e.g., an email address); a text entry bar 140 for data entry of a password associated with the user profile; a command button or hyperlink 150 to open a graphical user interface that enables a user to change the password (see FIG. 18); and a command button 160 to use the program as associated with the data provided to the text entry bars 140, 150. Suitably, once the software has been associated with a profile, a user may accomplish data entry via the software operating on computer hardware to the database so that the data is associated with the profile.

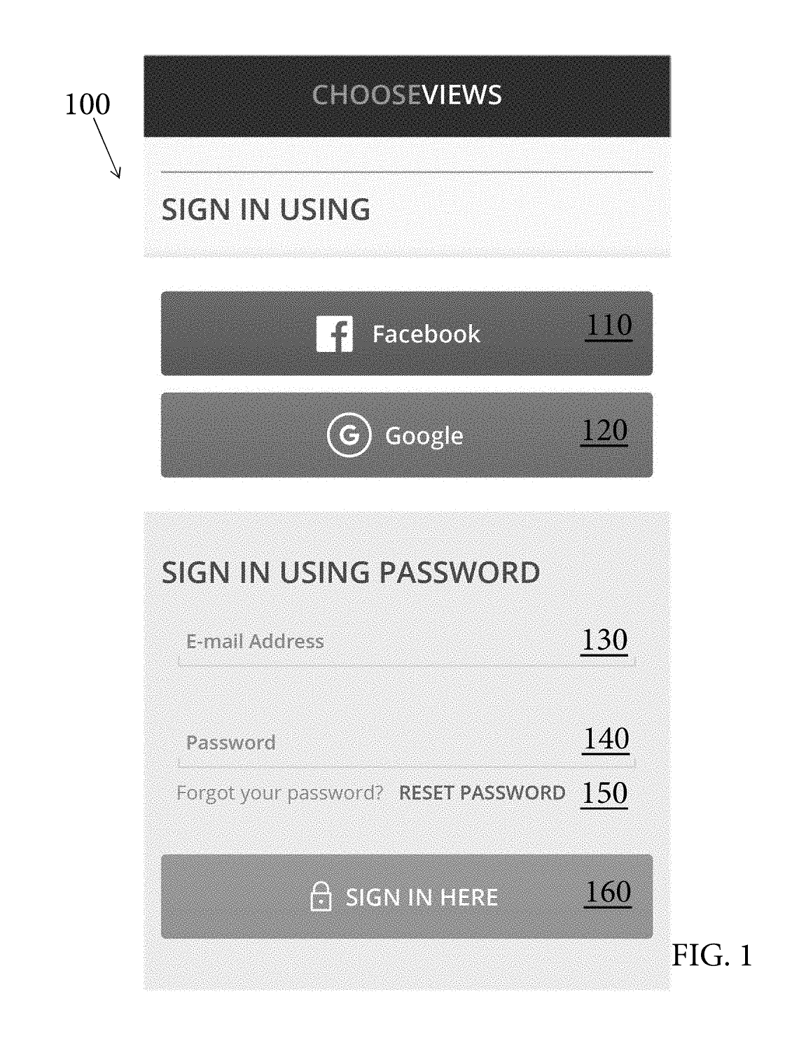

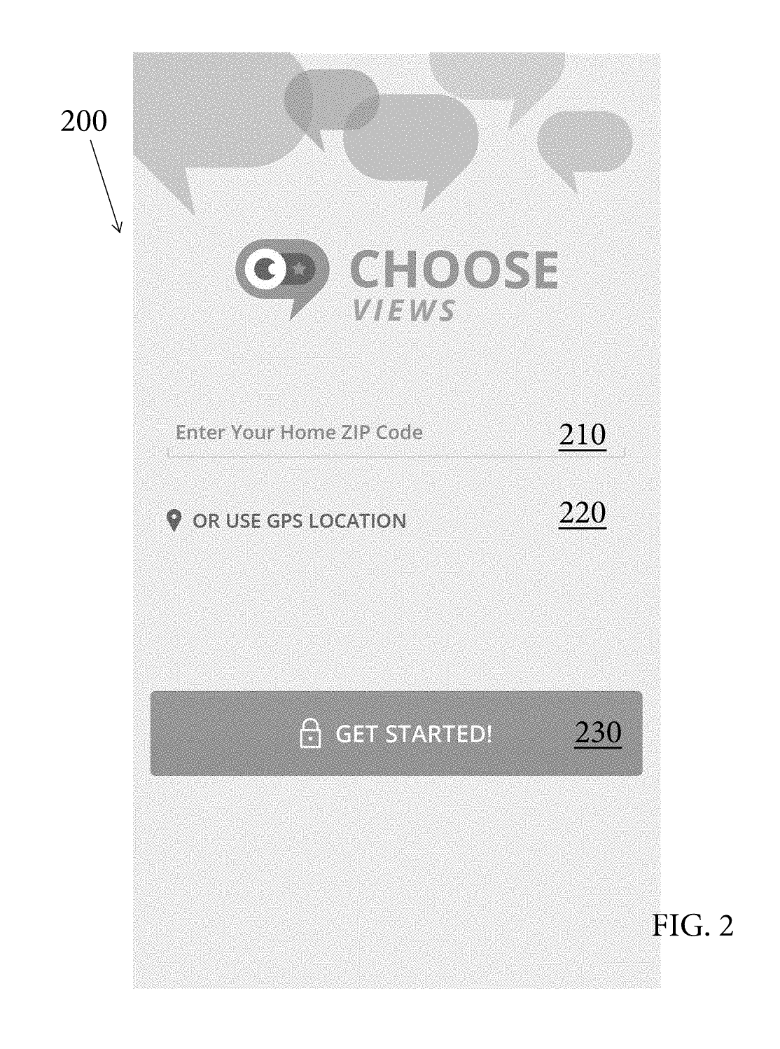

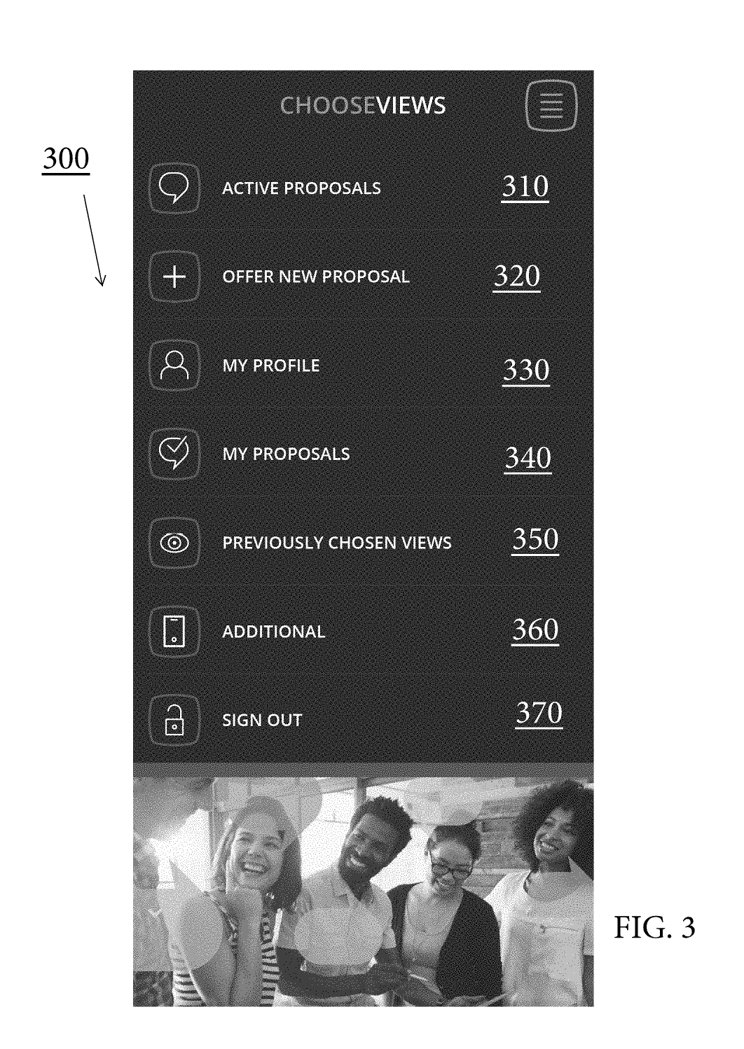

FIG. 2 is a preferred embodiment of a graphical user interface showing a typical “location finder” page 200. Suitably, the “location finder” page 200 enables logged-in profile to a geo-position either via a ZIP code or via global positioning satellite system tied to the computer hardware. In one embodiment, the “location finder” page 200 comprises: a text entry bar 210 for data entry of a ZIP code; a command button or hyperlink 220 for data entry of global position of from a global positioning satellite system; and, a command button 230 to tie the profile to the entered data and load the “main menu” page of the software shown in FIG. 3.

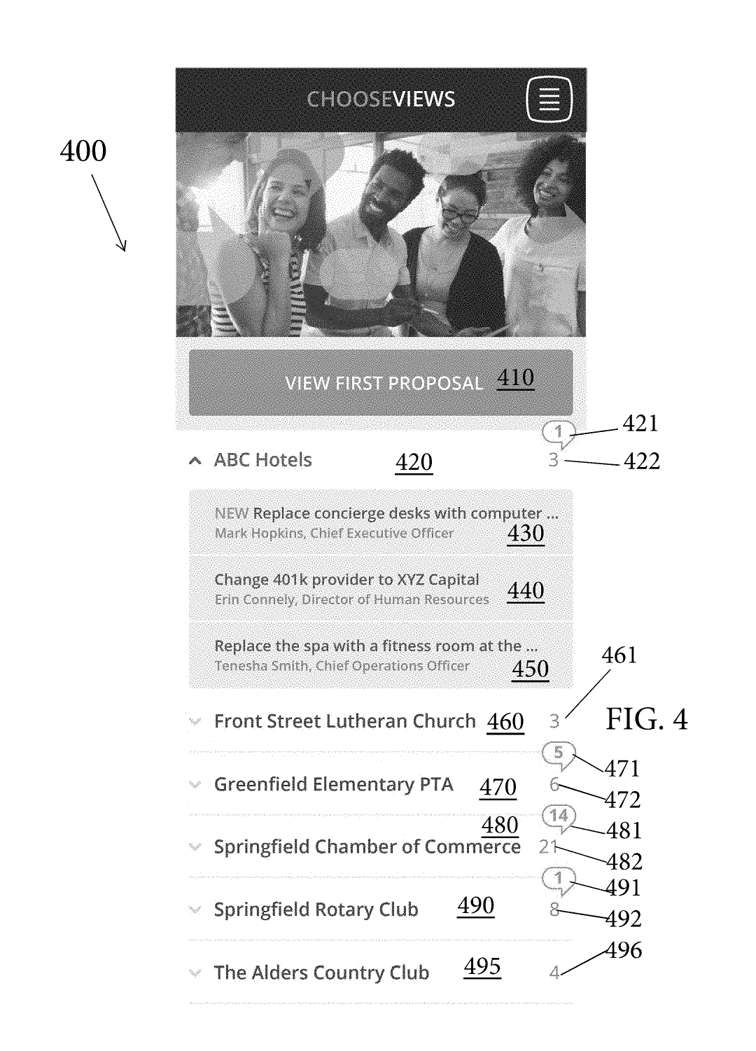

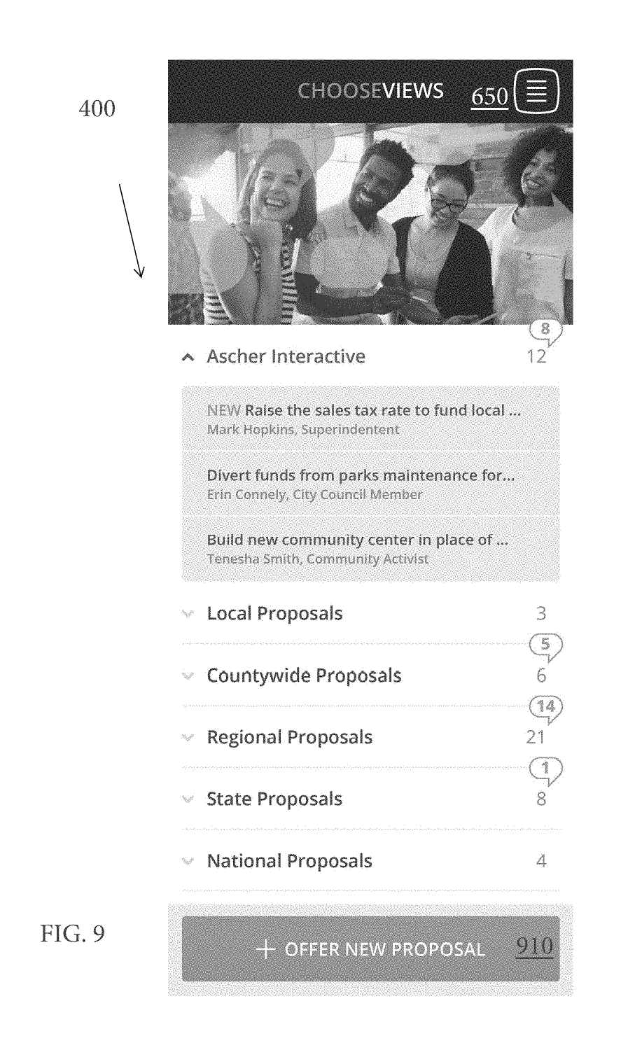

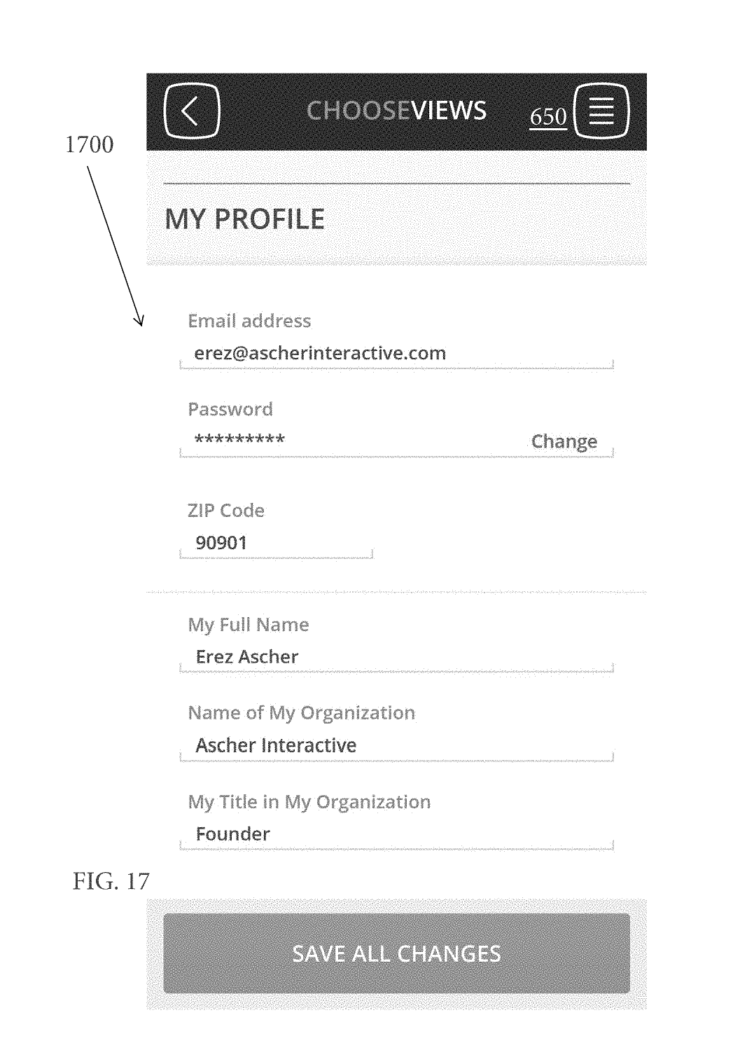

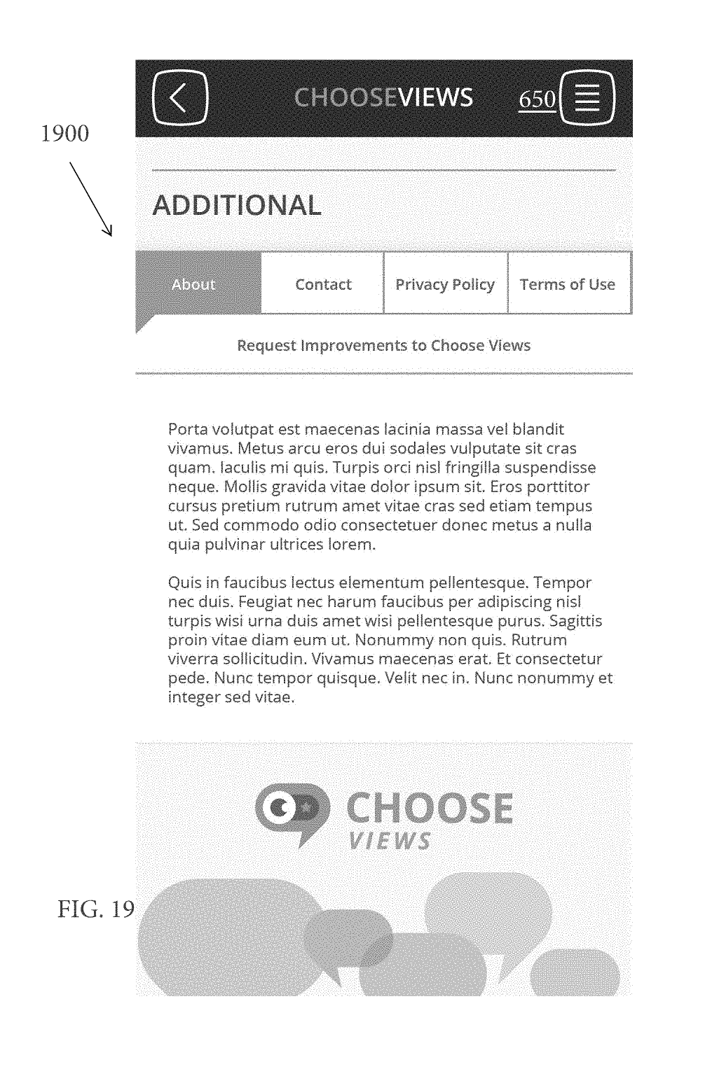

FIG. 3 is a preferred embodiment of a graphical user interface showing a typical “main menu” page. The “main menu” page sets a menu of the functionality for accessing the various functions of the disclosed software application. As shown, the “main menu” page 300 features: a command button 310 for accessing the active proposals page 400 (FIG. 4); a command button 320 for accessing the “offer new proposal”: page (FIG. 9); a command button 330 for accessing the “my profile” page (FIG. 17); a command button 340 for accessing a “my proposals” page; a command button 350 for accessing the “previously chosen views” page; a command button 360 for accessing the “additional” page 1900 (FIG. 19); and a command button 370 for untying the software from the logged in profile. Suitably, interacting with the relevant command button will initiate a displaying of the associated page.

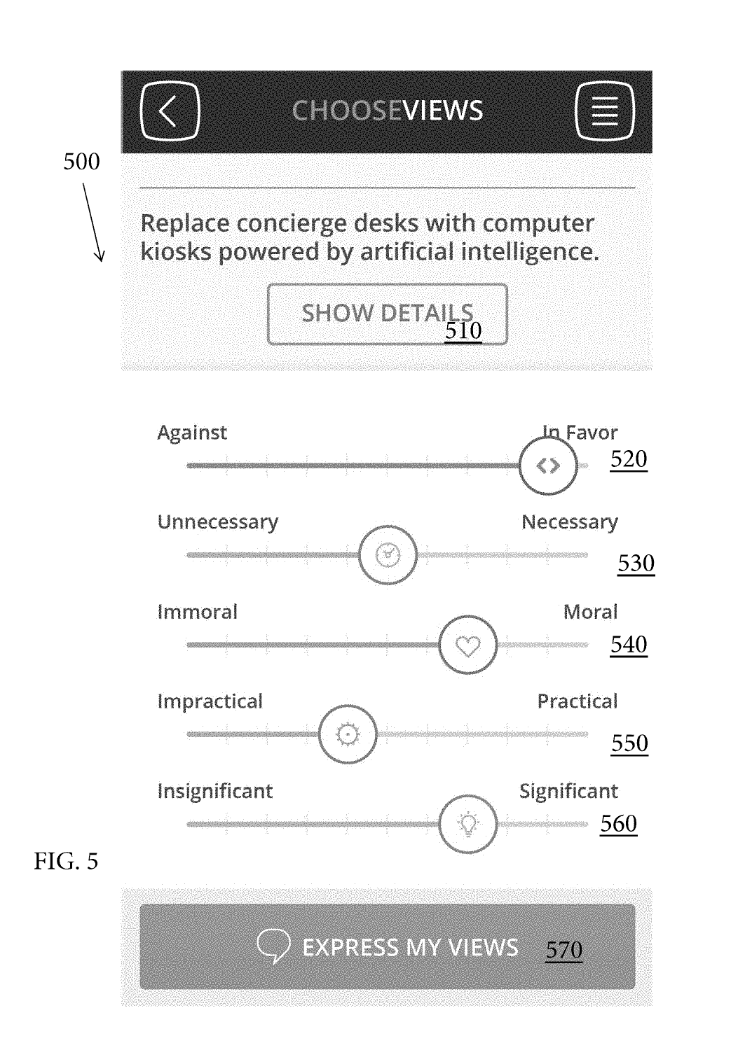

FIG. 4 is a preferred embodiment of a graphical user interface showing a typical “active proposal” page. Suitably, the “active proposal” page presents both (a) a command button 410 for enabling review by a stakeholder of the most recent active proposal for the stakeholder's review and (b) a list of drop down menus (420, 460, 470, 480, 490, 495) of grouped and active proposals presented to a stakeholder for review. The command button 410 for enabling review by a stakeholder of the most recent active proposal for the stakeholder's review suitably opens the “proposal response” page 500 (e.g., FIG. 5) associated with the latest (most current) active proposal. The dropdown menu buttons (420, 460, 470, 480, 490, 495) are each configured to i) identify a business, organization, or community that has active proposals, ii) identify the number of active proposals via a text box (422, 461, 472, 482, 492, 496) for that business, organization, or community, iii) identify the number of “NEW” active proposals via a text box (421, 471, 481, 491) for that business, organization, or community, and iv) present a drop down menu of command buttons (e.g., 430, 440, 450) associated with the proposals for that business, organization, or community. Referring to the drop down menu 420 for the fictitious organization, “ABC Hotels,” interaction with the menu drop down 420 presents three command buttons (430, 440, 450) associated with the three active and 1 new active proposals identified in the text boxes (Active: 422; NEW 421). The presented command buttons (430, 440, 450) are configured to present a description of the proposal and the proposer of the proposal. For instance, command button 430 presents the following proposal by Mark Hopkins, CEO for ABC Hotels: “Replace concierge desks with computer kiosks powered by artificial intelligence.” Suitably, interaction with the command buttons (e.g., 430, 440, 450) opens the “proposal response” page 500 (e.g., FIG. 5) associated with the selected active proposal associated with the command buttons.

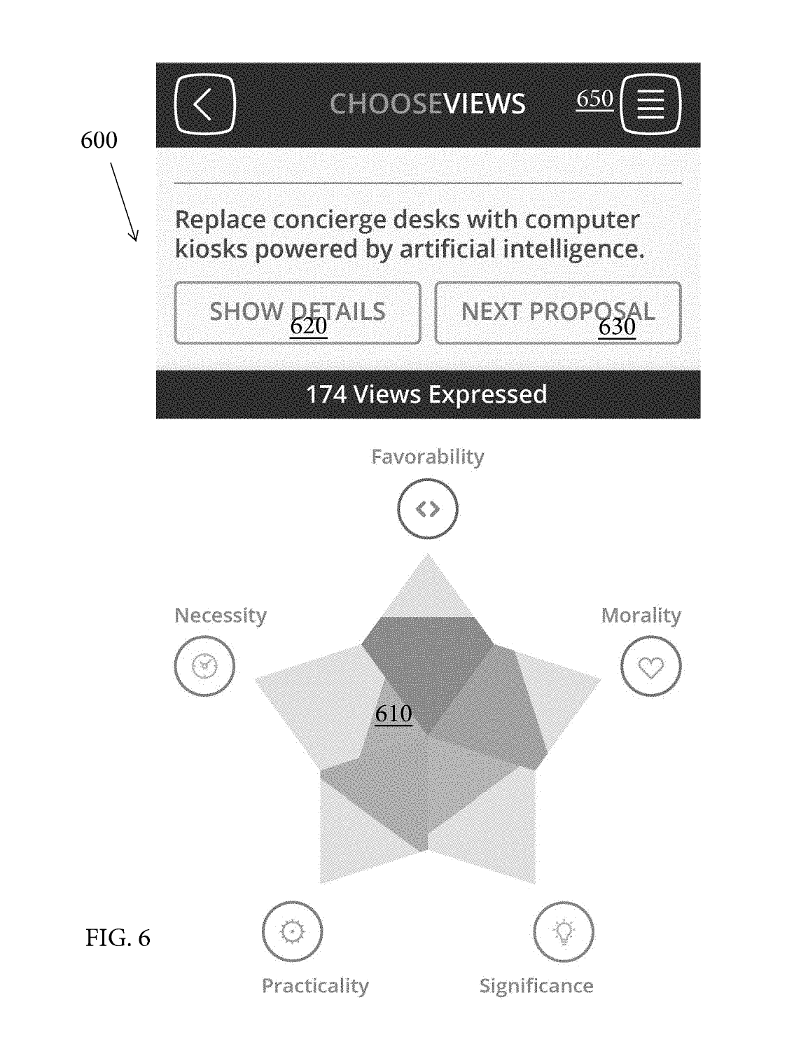

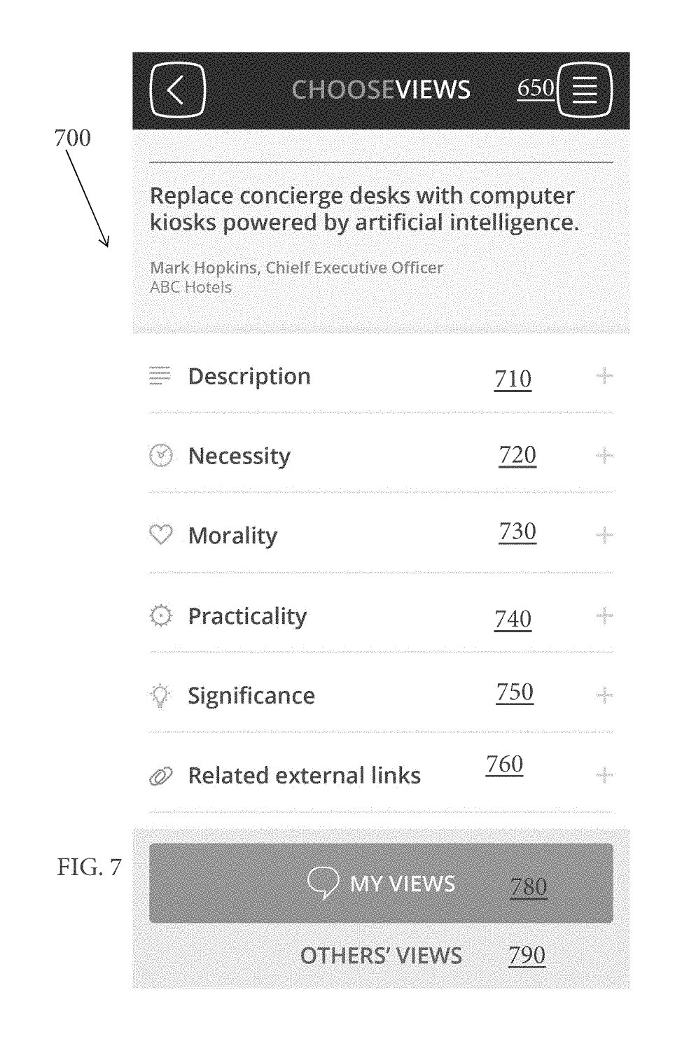

FIG. 5 is a preferred embodiment of a graphical user interface showing a typical “proposal response” page 500. Suitably, the page 500 depicted is representative of a proposal response page for any proposal selected from the “active proposal” page 400 (FIG. 4) but, in the context of the figures, is based on the proposal in FIG. 4 by Mark Hopkins, CEO for ABC Hotels: “Replace concierge desks with computer kiosks powered by artificial intelligence,” wherein the “proposal response” page is presented after interaction with the command button 410 for “view the first proposal” or the command button 430 from the drop down menu for ABC Hotel organization (FIG. 4). As shown in FIG. 5, the preferred embodiment of the “proposal response page” (i) identifies the proposal (e.g., “Replace concierge desks with computer kiosks powered by artificial intelligence”) and provides a command button 510 for accessing more details about the proposal via the view details page 700 (FIG. 7), (ii) presents five sliders (520, 530, 540, 550, 560) so a stakeholder may set a sliding-scale view for the proposals' favorability (520), necessity (530), morality (540), practicality (550), and significance (560), and (iii) a command button 570 for setting the stakeholders view, adding the data to the consensus, and presenting a graphical representation of said consensus via the “consensus view” page 600 (FIG. 6).

FIG. 6 is a preferred embodiment of a graphical user interface showing a typical “consensus view” page 600. Suitably, the page 600 depicted is representative of a “consensus view” page 600 for presenting the view current consensus regarding the given proposal, which is the set of averaged values as indicated by every contributing stakeholder using the sliders wherein when stakeholders express their views, they automatically are shown the current consensus view after interaction with the command button 570 for “express my views” (FIG. 5). Suitably, the page 600 presents the proposals and number of participating stakeholders (e.g., “174 views expressed”). As shown, the graphical representation 610 of the averaged stakeholder views may be a five pointed star where each arm of the star expresses the averaged sliding scale consensus view of the stakeholders with respect to the favorability, necessity, morality, practicality, and significance of the proposal (e.g., “Replace concierge desks with computer kiosks powered by artificial intelligence”). Suitably, once the graphical representation 610 has been viewed, the page 600 provides a command button 620 for accessing more details about the proposal via the view details page 700 (FIG. 7), a command button 630 for moving on to a “proposal response” page 500 (FIG. 5) for another active proposal, or a command button 650 for accessing the “main menu” page 300 (FIG. 3).

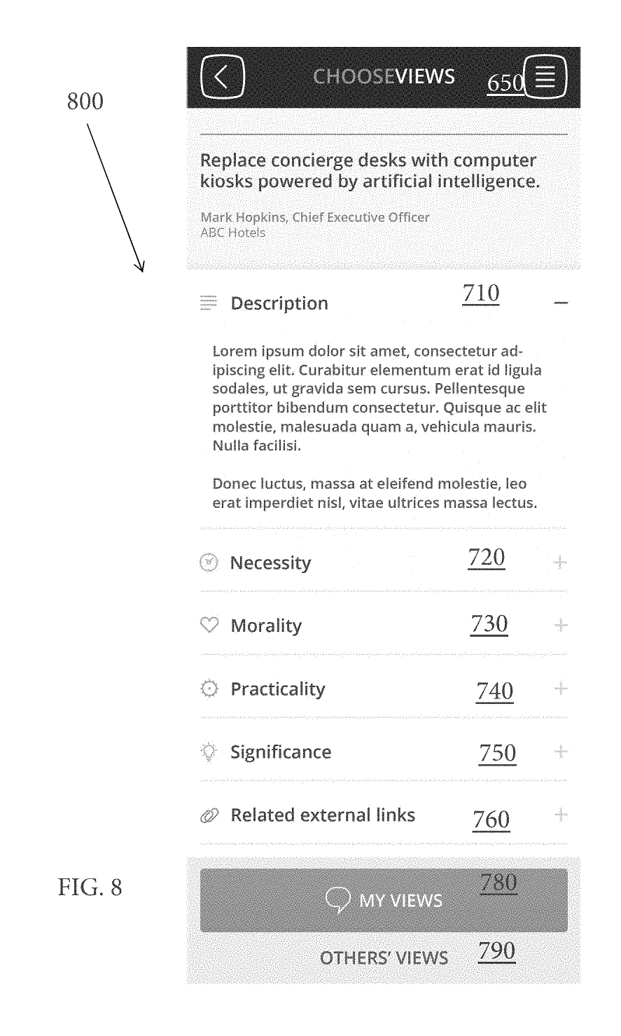

FIG. 7 is a preferred embodiment of a graphical user interface showing a typical “view details” page 700. FIG. 8 is a preferred embodiment of a graphical user interface showing a typical “expanded description of the view details” page 800. Suitably, the “view details” page 700 presents (a) the associated proposal and proposer and (b) a list of drop down tabs (710, 720, 730, 740, 750, 760) that are configured to present more detailed information regarding the topic of the associated drop down tab (710, 720, 730, 740, 750, 760). This functionality is illustrated via viewing FIGS. 7 and 8. Referring to those figures, the drop down tab 710 for “Description” of the associated proposal may be interacted with to show a text that sets out a description of the associated proposal

(FIG. 8) or close the drop down tab 710 (FIG. 7). Suitably, the other drop down tabs (720, 730, 740, 750, 760) may be expanded to show either (i) the sliding scale measure of the consensus view and a proposer's description of the proposals' necessity (720), morality (730), practicality (740), and significance (750) when the toggle switch 790 is active or (ii) show the sliding scale measure of the stakeholder's view and a proposer's description of the proposals the proposals' necessity (720), morality (730), practicality (740), and significance (750) when the command button or hyperlink 780 is interacted with by the user. The page 700, 800 may also suitably have a drop down tab 760 to show any external links with information about the proposal. Finally, the page 700, 800 features a command button 650 for accessing the “main menu” page 300 (FIG. 3).

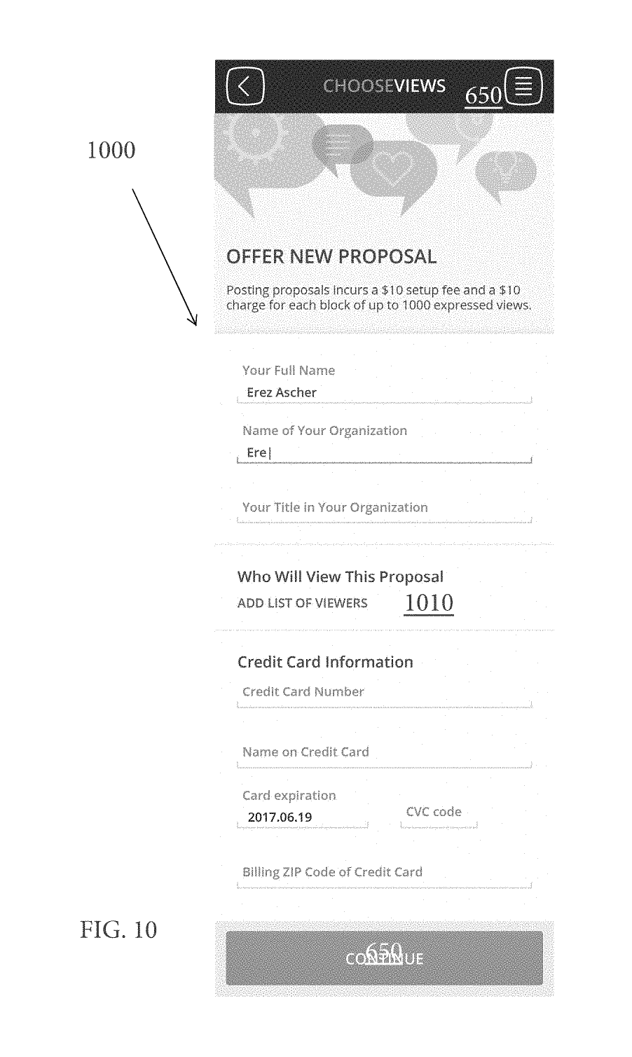

FIG. 9 is a preferred embodiment of a graphical user interface showing a typical “offer new proposal” page. Suitably, the “offer new proposal page” may be the same as the “active proposal” page 400 except with a command button 910 for presenting the “detailed offer new proposal” page 1000 (FIG. 10). The page 900 also features a command button 650 for accessing the “main menu” page 300 (FIG. 3).

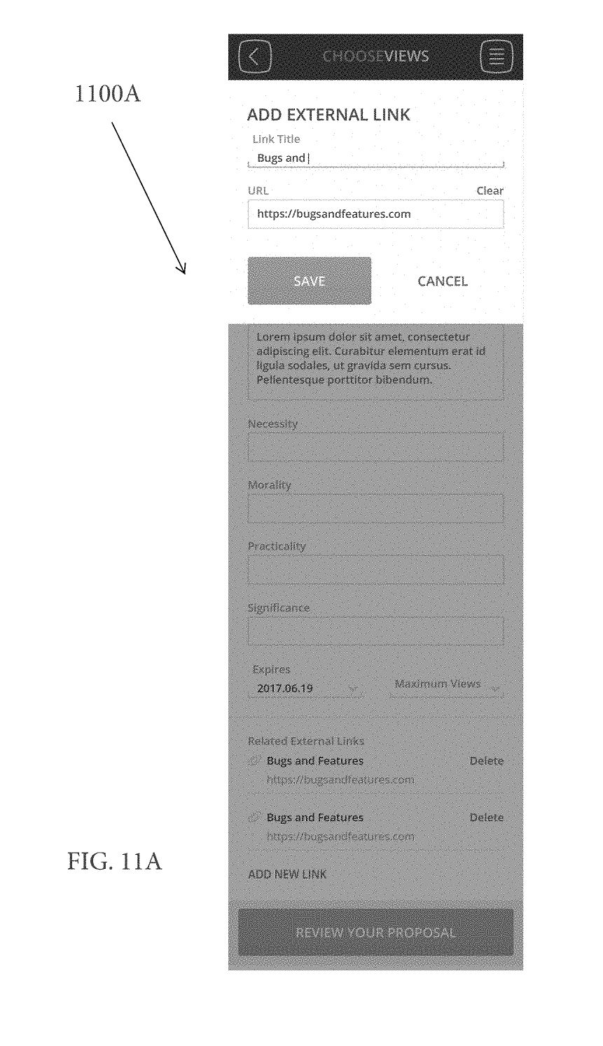

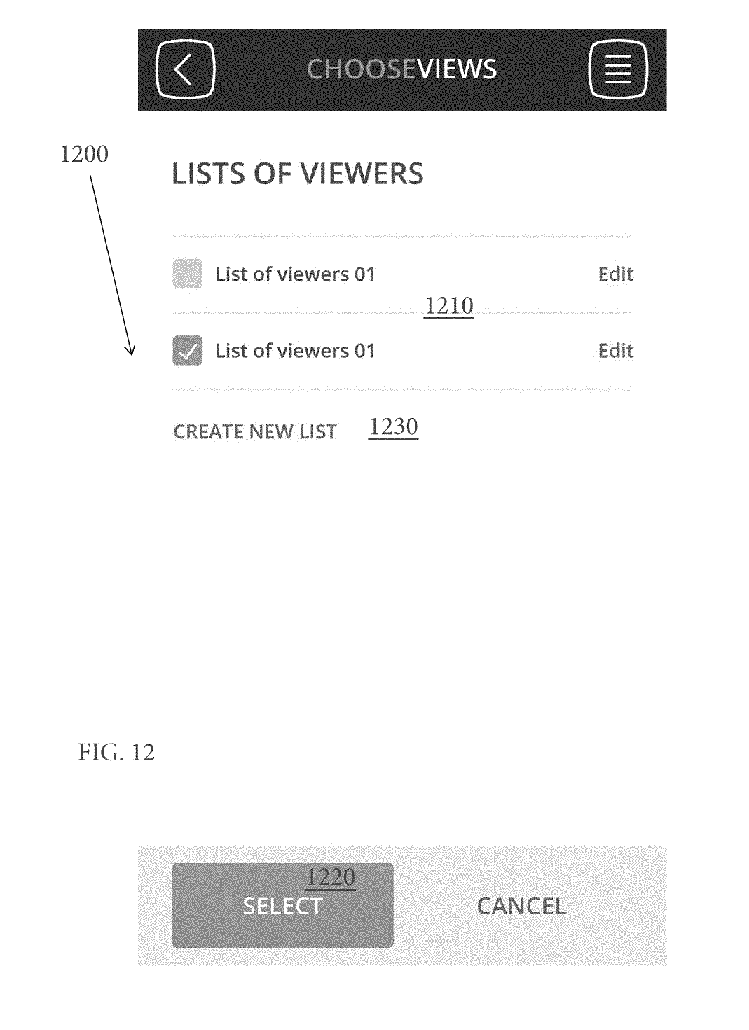

FIG. 10 is a preferred embodiment of a graphical user interface showing a typical “detailed offer new proposal” page 1000. As shown, the page 1000 serves a data entry functionality for the proposer's name, business, organization, or community name and billing information (e.g., whereby a fee may be charged per proposal). Suitably, the page 900 enables the proposer to restrict viewers via a hyperlink 910 (discussed in FIGS. 12 through 17) that can access the proposal via the software with information regarding the proposal and the input data may be viewed by a stakeholder view details page 700 (FIG. 7). The page 1000 also features a command button 650 for accessing the “main menu” page 300 (FIG. 3). The page 1000 also features a command button 650 for accessing the “main menu” page 300 (FIG. 3).

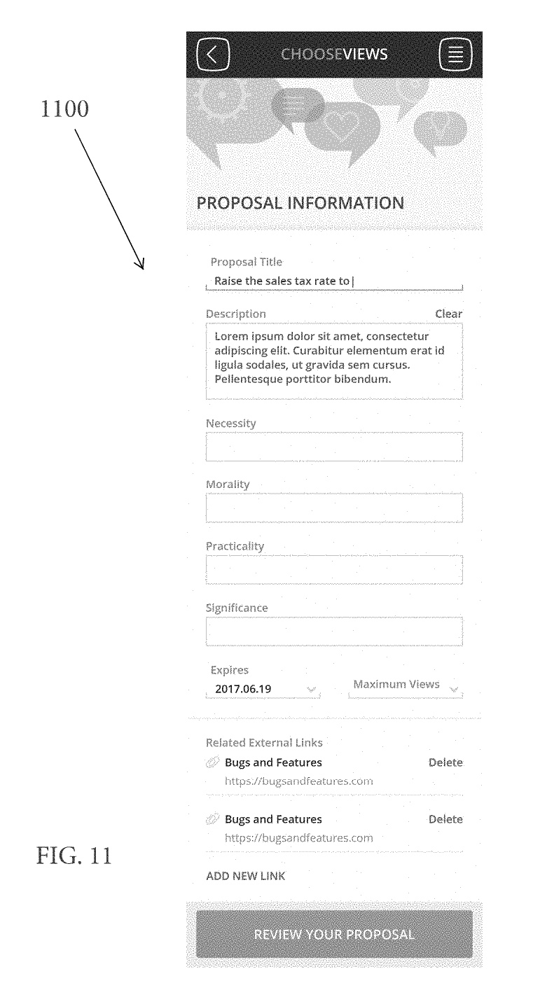

FIG. 11 is a preferred embodiment of a graphical user interface showing a typical “new proposal input” page. As shown, the page 1000 serves a data entry functionality for the proposer's title of the proposal, the proposer's description of the details, necessity, morality, practicality, and significance of the proposal. Suitably, the page enables the entry of external links with information regarding the proposal and the input data may be viewed by a stakeholder view details page 700 (FIG. 7). The page 1100 also features a command button 650 for accessing the “main menu” page 300 (FIG. 3).

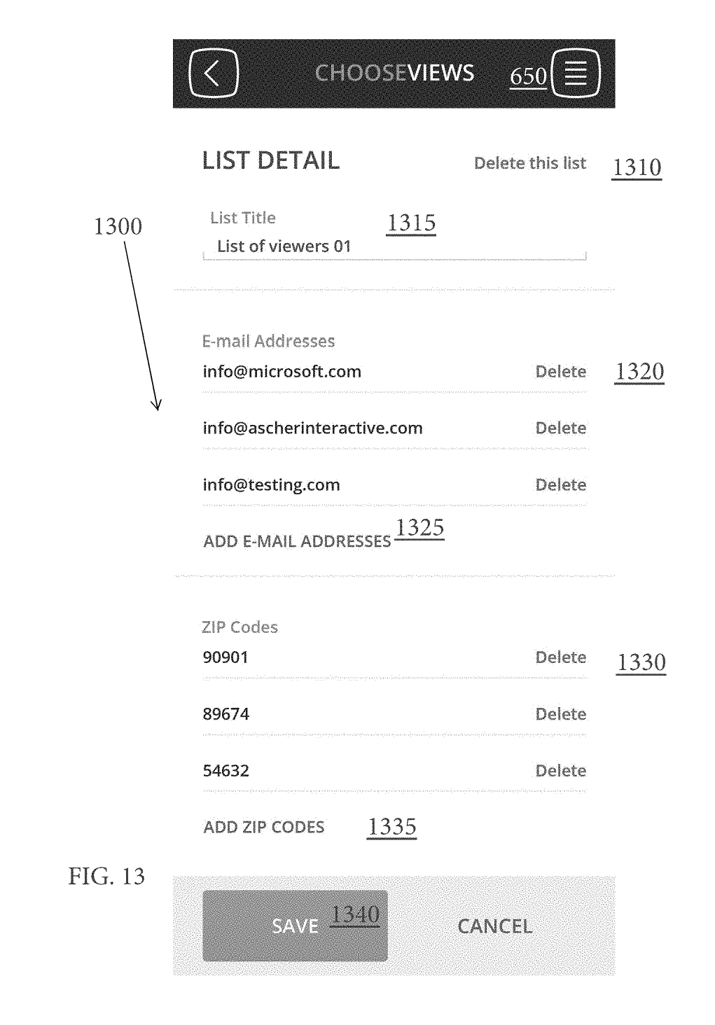

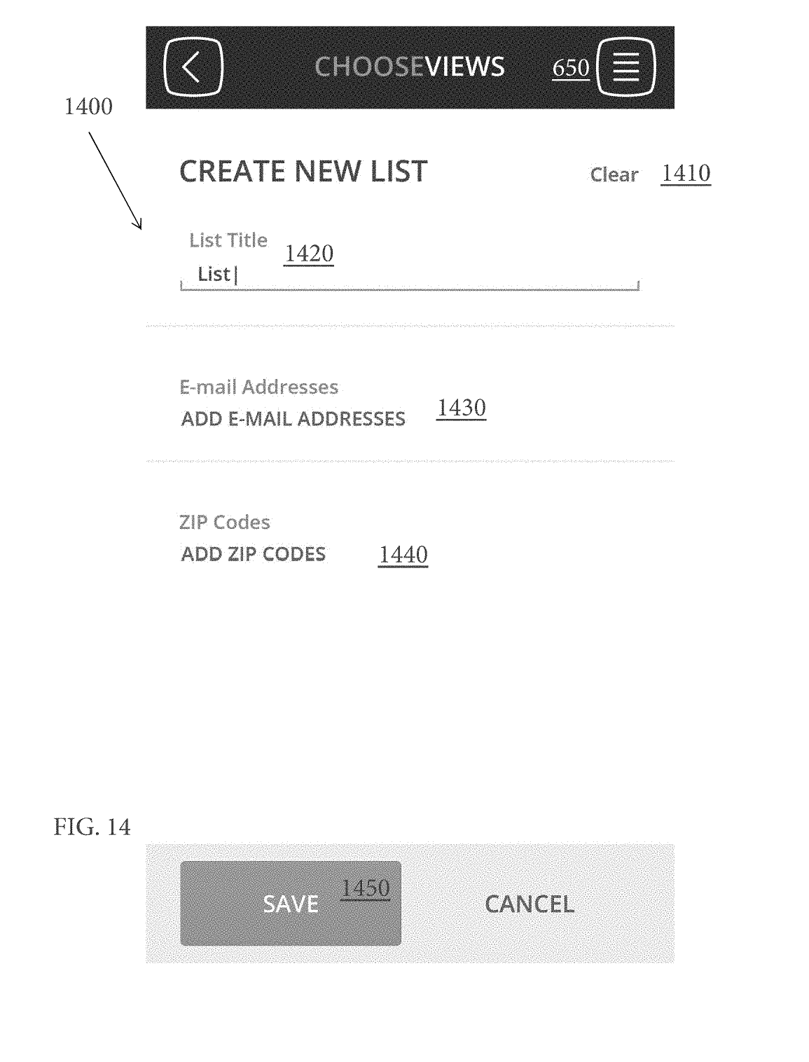

FIG. 12 is a preferred embodiment of a graphical user interface showing a typical “list of viewers” page 1200. Suitably, each proposer has the option to limit the viewers of his proposals to relevant stakeholders. The viewer lists are suitably the lists of people authorized to access the proposer's proposals. As shown, the page 1200 enables editing of established stakeholder lists via a checkbox menu 1210 and selection button 1220 or the creation of a new list via a command button or hyper link 1230. Suitably, interaction with the check box 1210 and select button will present the “list detail” page 1300 (FIG. 13) for editing the associated list and the command button or hyper link 1230 will present the “create new list” page 1400 (FIG. 14). FIG. 11A is a preferred embodiment of a graphical user interface showing a typical “add external link” page. The page 1200 also features a command button 650 for accessing the “main menu” page 300 (FIG. 3).

Suitably, relevant viewers may be identified via email address or ZIP codes. FIG. 13 is a preferred embodiment of a graphical user interface showing a typical “list detail” page 1300. As shown, an established list may be edited to delete email addresses or ZIP codes (1330, 1320) no longer applicable to the proposer's proposal, or add email addresses or ZIP codes (1325, 1335) that have become relevant. The title may be changed via text box 1315 or the whole list may also be deleted via a command button 1310. Finally, the changes to the list may be saved to the database via command button 1340. The page 1200 also features a command button 650 for accessing the “main menu” page 300 (FIG. 3).

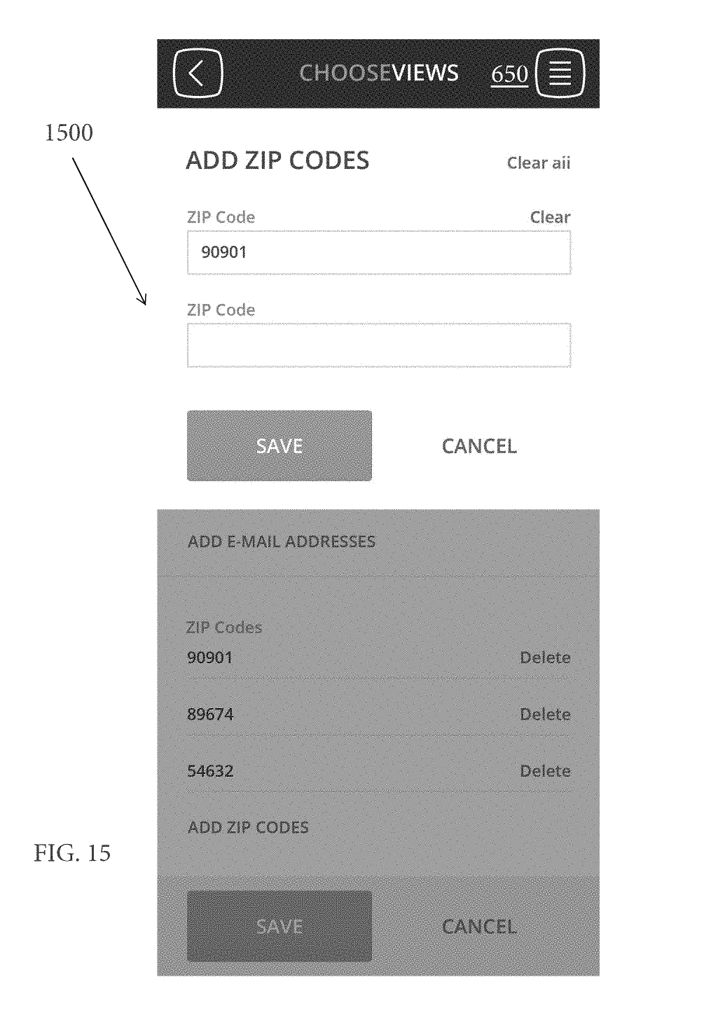

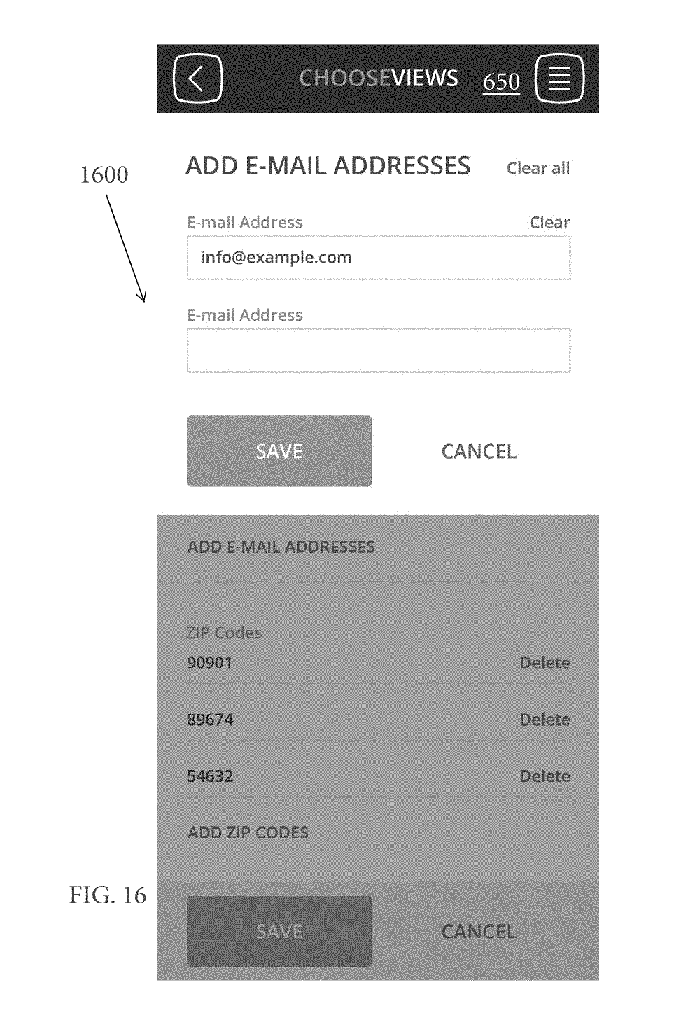

FIG. 14 is a preferred embodiment of a graphical user interface showing a typical “create new list” page 1400. Suitably, relevant viewers may be identified via email address or ZIP codes. As shown, a list of stakeholders may be added to include email addresses or ZIP codes (1430, 1440) of relevant stakeholders. FIG. 15 is a preferred embodiment of a graphical user interface showing a typical “add ZIP codes” page 1500 that will be presented after interaction with command button 1440 for data entry of relevant ZIP codes. FIG. 16 is a preferred embodiment of a graphical user interface showing a typical “add email address” page 1600 that will be presented after interaction with command button 1430 for data entry of relevant email addresses. Referring back to FIG. 14, the title of the list may be added via text box 1420 or the whole list may also be cleared via a command button 1410. Finally, the changes to the list may be saved to the database via command button 1340. The pages 1400, 1500, 1600 also feature a command button 650 for accessing the “main menu” page 300 (FIG. 3).

From the “main menu” page 300, a proposer or stakeholder has the option of setting a profile that includes the email address and ZIP code so that the proposer or stakeholder may be associated with relevant proposals. The profile may also include a password. FIG. 17 is a preferred embodiment of a graphical user interface showing a typical “my profile” page 1700. The “my profile” page 1700 enables the functionality of editing the proposer's or stakeholder's profile. FIG. 18 is a preferred embodiment of a graphical user interface showing a typical “change password” page 1800. The “change password” page 1800 enables the functionality of editing the proposer's or stakeholder's profile password. The pages 1700, 1800 also feature a command button 650 for accessing the “main menu” page 300 (FIG. 3).

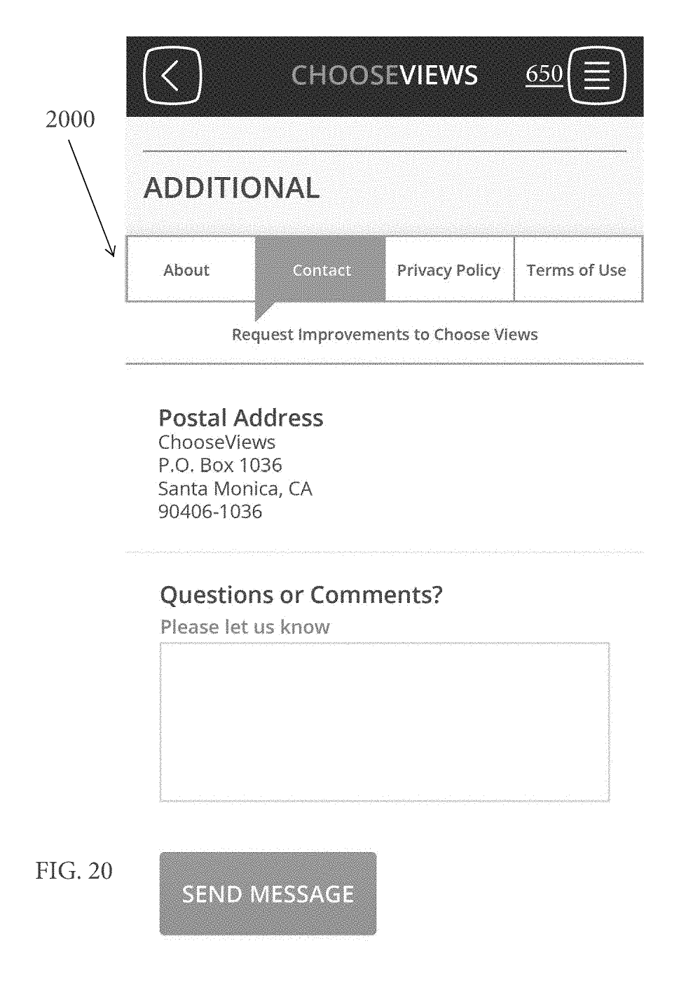

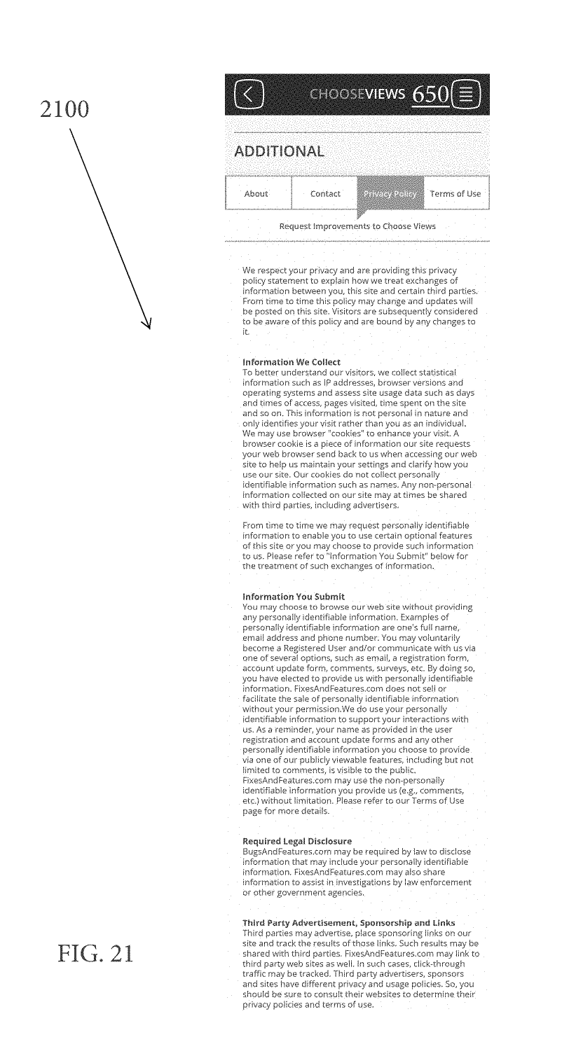

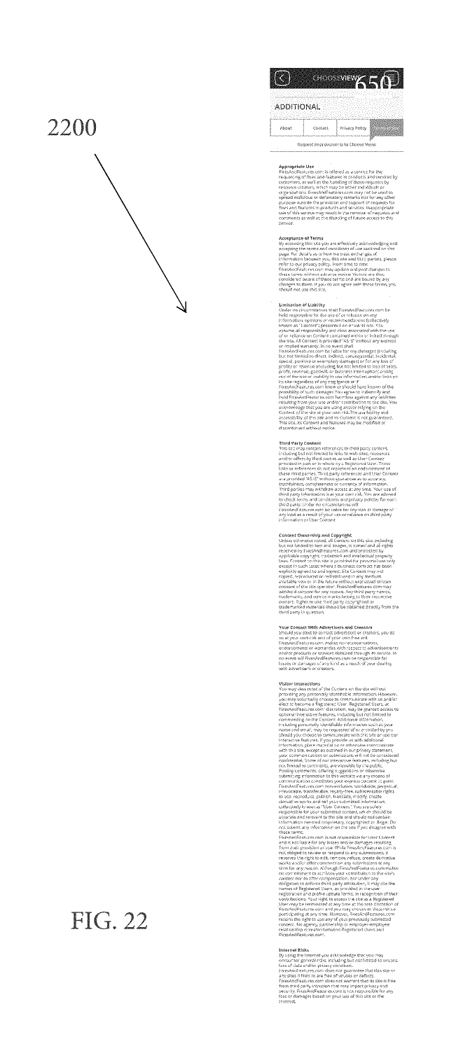

FIG. 19 is a preferred embodiment of a graphical user interface showing a typical “additional” page. The page presents a menu of drop down tabs that each present additional information about the software and related system. For instance, a contact drop down tab, a privacy policy tab, and a terms of use page may be associated with the drop down menu. FIG. 20 is a preferred embodiment of a graphical user interface showing a typical “contact” page. FIG. 21 is a preferred embodiment of a graphical user interface showing a typical “privacy policy” page. Finally, FIG. 22 is a preferred embodiment of a graphical user interface showing a typical “terms of use” page.

In one mode of operation, proposers offer proposals for consideration by stakeholders using the disclosed system. Software within the system is configured to enable proposers to define their proposal's title and write a description of their proposal, indicate their view of the necessity, morality, practicality, significance, and any external links or sources of information. Software within the system further is configured to enable proposers to define the stakeholders via various methods including by providing email address lists, ZIP codes and the like. Ultimately, the software enables stakeholders to use the system to review proposals that affect them and input their view of the necessity, morality, practicality, significance, and favorability of the proposal. In one embodiment, the stakeholder's views are input via sliders displayed on a graphical user interface (GUI). Both proposers and stakeholders may also view details regarding individual proposals and view the current consensus regarding a given proposal, which is the set of averaged values as indicated by stakeholders using the sliders. When stakeholders express their views, they automatically are shown the current consensus view.

Unlike a survey, the system requires no selection of options or entry of text in order to express one's views. The system may also be distinct from a survey in that it systematizes people's views regarding proposals on the basis of the dimensions of favorability, necessity, morality, practicality, and significance.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. Software installed on the memory of computer hardware wherein:
a. the software is configured to enable proposers to define its proposal's title and write a description of their proposal, indicate their view of the necessity, morality, practicality, significance, and any external links or sources of information;
b. the software is further configured to enable proposers to define the stakeholders;
c. the software is further configured to enable stakeholders to review the proposals that affect them and input their view of the necessity, morality, practicality, significance, and favorability of the proposal; and,
d. present a consensus view on a graphical user interface.

2. The software of claim 1 wherein the software is further configured to enable the stakeholder's views to be input via sliders displayed on a graphical user interface; and wherein the software is configured to enable both proposers and stakeholders to view details regarding individual proposals and view the current consensus regarding any given proposal, which is the set of averaged values as indicated by stakeholders using the sliders.

3. The software of claim 2 wherein, when stakeholders express their views, they automatically are shown the current consensus view.
